(19) United States
(12) Patent Application Publication
(10) Pub. No.: US 2008/0080848 A1
(43) Pub. Date: Apr. 3, 2008

(54) CAMERA FOCUSING SYSTEM AND METHOD THEREOF

(75) Inventor: Jung-Che Tsai, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/611,148

(22) Filed: Dec. 15, 2006

(30) Foreign Application Priority Data
Oct. 3, 2006 (TW) 95136695

(51) Int. Cl. G03B 13/00

(52) U.S. Cl. 396/127

(57) ABSTRACT

A camera focusing system and a method thereof are provided. The focus of the camera is moved to three equidistant reference positions Xᵢ, Xⱼ and Xₖ to get three image contrasts Yᵢ, Yⱼ and Yₖ respectively. Then, quadratic equation Y=aX²+bX+c is solved with (Xᵢ, Yᵢ), (Xⱼ, Yⱼ), and (Xₖ, Yₖ) to obtain the coefficients a, b and c. Accordingly equation Xₘ=(−b)/(2a)=Xⱼ+s(Yₖ−Yᵢ)/2(2Yⱼ−Yₖ−Yᵢ) is solved to get the optimal target focusing position Xₘ. According to the present invention, the optimal focusing position can be obtained instantly and the exposure time can be reduced by utilizing least reference points and simple procedure.

### CROSS-REFERENCE TO RELATED APPLICATION

This application claims the priority benefit of Taiwan application serial no. 95136695, filed Oct. 3, 2006. All disclosure of the Taiwan application is incorporated herein by reference.

### BACKGROUND OF THE INVENTION

1. Field of the Invention

The present invention relates to a camera focusing method. More particularly, the present invention relates to a method and a system for quickly obtaining the optimal focusing position by using least samplings.

2. Description of Related Art

Along with the development of technology and widespread of digital apparatuses, digital products such as digital camera (DC) and digital video camcorder (DV) have become indispensable in our life, and accordingly the development of digital products has become one of the major subjects to various manufacturers.

DC is one of the most important digital products, and the focusing technique adopted by a DC is a key factor to determine the quality of the DC besides the imaging quality of the DC. Focusing has to be both quick and accurate, and the focusing speed and effect of a DC directly affect the imaging speed and quality of the DC.

Currently, the optical zoom lens of a DC is driven by a stepping motor to zoom, and a stepping motor with fifty steps will be described below as an example. FIG. 1 is a flowchart illustrating the conventional view-finding procedure. Referring to FIG. 1, conventionally, a first view-finding to a subject is performed first (step S100). Then the photosensitive component is left for exposure (step S102) and a first image contrast or resolution is calculated (step S104). In step S106, whether the stepping motor has reached its limitation and cannot go forward (or backward) any further is determined. If the stepping motor has not reached its limitation, the stepping motor is controlled to step forward (or backward) to focus (step S100), expose (step S102), and calculate image contrast (step S104) again until the stepping motor has reached its limitation and cannot go forward (or backward) anymore.

In other words, the prior art must drives the stepping motor to operate step by step, calculates the image contrast of the fifty steps, and compares the image contrast of the fifty steps. Thereby, the position of the optimal image contrast is obtained (step S108). Such method is very time-consuming even through the optimal image contrast position can be obtained.

Various algebra algorithms are provided to reduce the exposure times and focusing time of a DC. For example, in Taiwan Patent No. 1233523, a plurality of sampling points are located by using a conventional sampling method and a complex judgment rule, four reference points are then taken from the sampling points, a slope is calculated with the left two reference points and another slope is calculated with the right two reference points, and the two slopes are extended to obtain the optimal focusing position at the intersection of the two slopes. Too many reference points are required by the conventional technique and it is very complex to obtain the optimal focusing position by extending two slopes. Moreover, different calculations are required for different situations. For example, if an abnormality is determined and only one slope can be obtained, then the another slope has to obtain with extended symmetrical means. The error may be caused and the judgment procedure becomes very complex, accordingly a great deal of time is consumed and complex calculation circuit is required.

Accordingly, a camera focusing system and a method thereof are provided in the present invention for resolving the foregoing problems.

### SUMMARY OF THE INVENTION

Accordingly, the present invention is directed to provide a camera focusing method, wherein the image contrasts Yᵢ, Yⱼ, and Yₖ at three random reference positions Xᵢ, Xⱼ, and Xₖ in the moving path of the focus are obtained and calculated so as to quickly obtain the optimal focusing position, thus, the focus-finding procedure is simplified and the time required thereof is reduced.

According to another aspect of the present invention, a camera focusing system is provided, wherein the image contrasts Yᵢ, Yⱼ, and Yₖ at three random reference positions Xᵢ, Xⱼ, and Xₖ in the moving path of the focus are obtained and calculated to obtain the optimal focusing position through simple procedure and reduced exposure times.

The present invention provides a camera focusing method for controlling the focus of the camera to move to a target focusing position to capture an image. The camera focusing method includes following steps. First, the focus is moved along a focus-finding direction, wherein the moving path of the focus contains at least three reference focusing positions Xᵢ, Xⱼ, and Xₖ. The focus of the camera is controlled to move to the reference focusing positions Xᵢ, Xⱼ, and Xₖ and further to obtain image contrasts Yᵢ, Yⱼ, and Yₖ respectively. Next, simultaneous equations Yᵢ=aXᵢ²+bXᵢ+c, Yⱼ=aXⱼ²+bXⱼ+c, and Yₖ=aXₖ²+bXₖ+c are solved to get the coefficients a, b, and c. After that, the target focusing position Xₘ=(−b)/(2a) is calculated. Finally, the focus of the camera is controlled to move to the target focusing position Xₘ for capturing an image.

According to another aspect of the present invention, a camera focusing method is provided for controlling the focus of the camera to move to a target focusing position to capture an image. The focusing method includes following steps. The focus is moved along a focus-finding direction, wherein the moving path of the focus contains at least three reference focusing positions Xᵢ, Xⱼ, and Xₖ, and all the distances between the reference focusing positions Xᵢ, Xⱼ, and Xₖ are s. The camera is controlled to focus at the reference focusing positions Xᵢ, Xⱼ, and Xₖ and to obtain image contrasts Yᵢ, Yⱼ, and Yₖ respectively. The target focusing position Xₘ=Xⱼ+[s(Yₖ−Yᵢ)/2(2Yⱼ−Yₖ−Yᵢ)] is then calculated. The focus of the camera is controlled to move to the target focusing position Xₘ for capturing an image.

According to the camera focusing method in an exemplary embodiment of the present invention, if the image contrast of the present reference focusing position is greater than that of the previous reference focusing position, the focus is moved along the focus-finding direction to the next reference focusing position and another image contrast is obtained. If the image contrast of the present reference focusing position is smaller than that of the previous reference focusing position, the present reference focusing position, the previous reference focusing position, and the even previous reference focusing position are respectively Xₖ, Xⱼ, and Xᵢ.

According to the camera focusing method in an exemplary embodiment of the present invention, a plurality of image contrasts are obtained at a plurality of reference focusing positions in the moving path of the focus. Then the image contrasts are compared with each other and the reference focusing position with the largest image contrast is considered as Xⱼ, the previous reference focusing position and the next reference focusing position adjacent to the reference focusing position Xⱼ are respectively Xᵢ and Xₖ.

According to yet another aspect of the present invention, a camera focusing system is provided. The system includes an optical focusing component, a servo unit, an image-capturing unit, and a control unit. The servo unit is coupled to the optical focusing component for driving the optical focusing component, so as to move the focus of the camera along a focus-finding direction. The image-capturing unit is disposed on the optical path of the optical focusing component for capturing an image. The control unit is electrically connected to the servo unit and the image-capturing unit. The control unit controls the servo unit so as to move the focus to the target focusing position, and the control unit controls the image-capturing unit to capture an image. Wherein the moving path of the focus contains at least three reference focusing positions Xᵢ, Xⱼ, and Xₖ, and all the distances between the reference focusing positions Xᵢ, Xⱼ, and Xₖ are s. The control unit controls the image-capturing unit and the servo unit to focus at the reference focusing positions Xᵢ, Xⱼ, and Xₖ and obtain image contrasts Yᵢ, Yⱼ, and Yₖ respectively. The control unit calculates the target focusing position Xₘ=Xⱼ+s(Yₖ−Yᵢ)/2(2Yⱼ−Yₖ−Yᵢ). The control unit controls the focus of the camera to move to the target focusing position Xₘ.

According to the camera focusing system in an exemplary embodiment of the present invention, if the image contrast of the present reference focusing position is greater than that of the previous reference focusing position, the control unit further moves the focus along the focus-finding direction to the next reference focusing position to obtain another image contrast. If the image contrast of the present reference focusing position is smaller than the previous reference focusing position, the present reference focusing position, the previous reference focusing position, and the even previous reference focusing position are respectively Xₖ, Xⱼ, and Xᵢ.

According to the camera focusing system in an exemplary embodiment of the present invention, the control unit respectively obtains a plurality of image contrasts at a plurality of reference focusing positions in the moving path of the focus. The control unit compares the image contrasts and selects the reference focusing position with the largest image contrast as Xⱼ. The previous reference focusing position and the next reference focusing position adjacent to the reference focusing position Xⱼ are respectively Xᵢ, and Xₖ.

As described above, image contrasts Yᵢ, Yⱼ, and Yₖ are obtained at three random reference positions Xᵢ, Xⱼ, and Xₖ in the moving path of the focus and are calculated so as to quickly obtain the optimal focusing position, so that the focusing procedure is simplified and the time required is reduced. According to an embodiment of the present invention, the foregoing (Xᵢ, Yᵢ), (Xⱼ, Yⱼ), and (Xₖ, Yₖ) can be used in the quadratic equation Y=aX²+bX+c to solve the coefficients a, b, and c, so that the optimal target focusing position can be obtained as Xₘ=(−b)/(2a). According to another embodiment of the present invention, all the distances between the foregoing reference positions Xᵢ, Xⱼ, and Xₖ are s, then the optimal target focusing position Xₘ=Xⱼ+s(Yₖ−Yᵢ)/2(2Yⱼ−Yₖ−Yᵢ). Accordingly, the exposure time of the camera can be reduced and the optimal focusing position can be obtained quickly with least reference points and a simple procedure.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating the conventional view-finding procedure.

FIG. 2 is a block diagram of a camera focusing system according to an exemplary embodiment of the present invention.

FIG. 3 is a graph of an image contrast with equidistant reference points according to an exemplary embodiment of the present invention.

FIG. 3A is a flowchart illustrating the camera focusing method according to an exemplary embodiment of the present invention.

FIG. 4 is a flowchart illustrating the camera focusing method according to an exemplary embodiment of the present invention.

FIG. 5 is a graph of an image contrast with reference points of different distances according to an exemplary embodiment of the present invention.

FIG. 6 is a flowchart illustrating the procedure of finding the reference focusing positions Xᵢ, Xⱼ, and Xₖ according to an exemplary embodiment of the present invention.

FIGS. 7A˜7C are graphs of an image contrast for finding the reference focusing position according to an exemplary embodiment of the present invention.

FIG. 8 is a flowchart illustrating the procedure of finding the reference focusing positions Xᵢ, Xⱼ, and Xₖ according to another exemplary embodiment of the present invention.

FIG. 9 is another graph of an image contrast for finding the reference focusing position according to an exemplary embodiment of the present invention.

FIG. 10 is a flowchart illustrating the procedure of finding the reference focusing positions Xᵢ, Xⱼ, and Xₖ according to yet another exemplary embodiment of the present invention.

FIG. 11 is yet another graph according to an exemplary embodiment of the present invention.

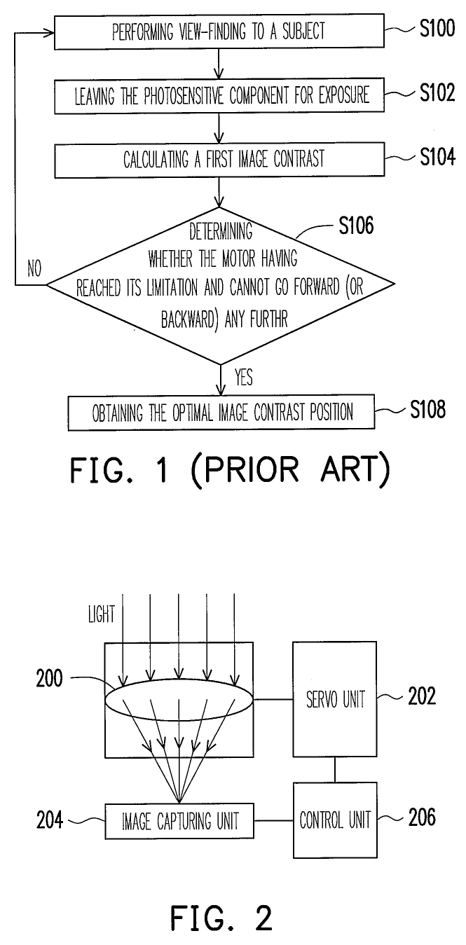

### DESCRIPTION OF EMBODIMENTS

In following embodiments, when a component is said to be “connected” or “coupled” to another component, it may be connected or coupled to the other component directly or via some other components. When a component is said to be “directly connected” or “directly coupled” to another component, there won't be any component in between.

Embodiments of the present invention will be described below.

FIG. 2 is a schematic block diagram of a camera focusing system according to an exemplary embodiment of the present invention. Referring to FIG. 2, the camera focusing system includes an optical focusing component 200, a servo unit 202, an image-capturing unit 204, and a control unit 206. The servo unit 202 is coupled to the optical focusing component 200 for driving the optical focusing component 200, so as to move the focus of the camera along a focus-finding direction. Here a stepping motor and the corresponding driving circuit are used for implementing the servo unit 202. The image-capturing unit 204 is disposed on the optical path of the optical focusing component 200 for capturing an image, and which may be implemented with a photosensitive complementary metal-oxide semiconductor (CMOS) or a charge-coupled device (CCD). The control unit 206 is electrically connected to the servo unit 202 and the image-capturing unit 204 and controls the servo unit 202 to move the focus to the target focusing position and the image-capturing unit 204 to capture an image.

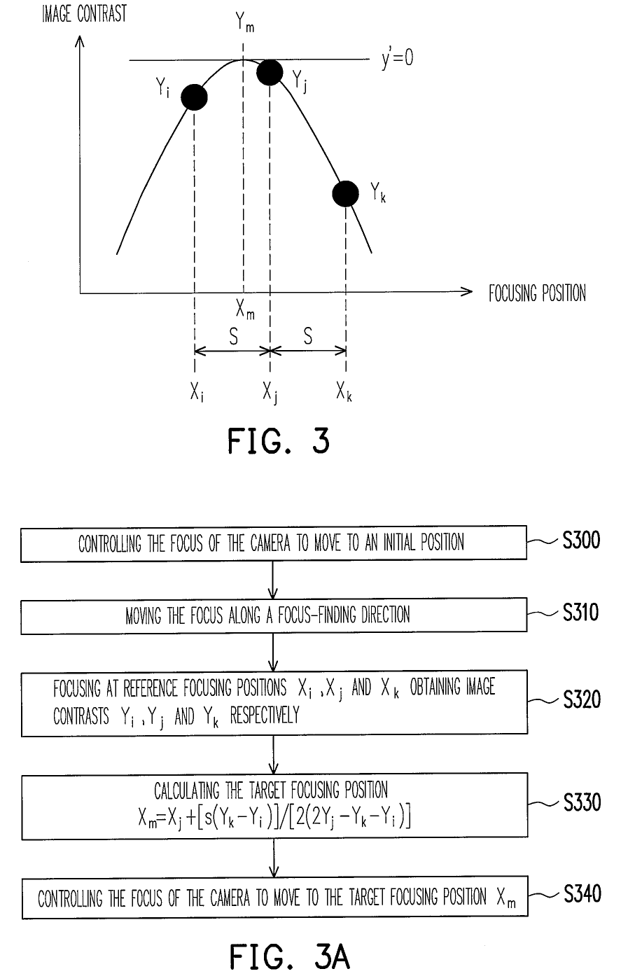

FIG. 3 is a graph of an image contrast with equidistant reference points according to an exemplary embodiment of the present invention. FIG. 3A is a flowchart illustrating the camera focusing method according to an exemplary embodiment of the present invention. Referring to FIG. 3 and FIG. 3A, in step S300, the focus of the camera is controlled to move to an initial position before focusing. The initial position may be preset according to the design requirement. In step S310, the focus of the camera is moved along a focus-finding direction, wherein the moving path of the focus contains at least three reference focusing positions Xᵢ, Xⱼ, and Xₖ, and all the distances between the reference focusing positions Xᵢ, Xⱼ, and Xₖ are s. In step S320, the camera is controlled to focus at the reference focusing positions Xᵢ, Xⱼ, and Xₖ to obtain image contrasts Yᵢ, Yⱼ, and Yₖ respectively. In step S330, the target focusing position Xₘ=Xⱼ+[s(Yₖ−Yᵢ)/2(2Yⱼ−Yₖ−Yᵢ)] is calculated. In step S340, the focus of the camera is controlled to move to the target focusing position Xₘ.

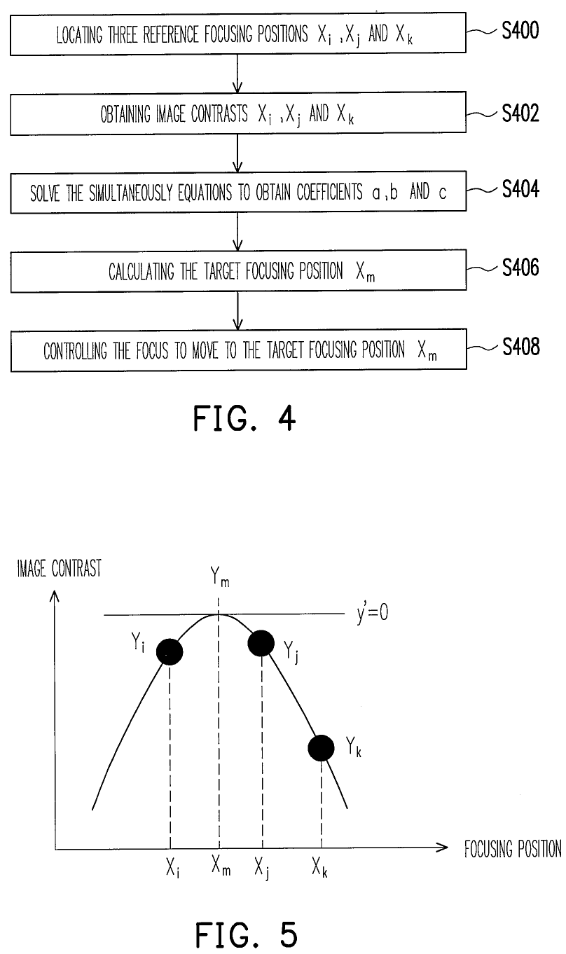

FIG. 4 is a flowchart illustrating the camera focusing method according to an exemplary embodiment of the present invention. Referring to FIGS. 2, 3, and 4 again, during the focusing procedure, the control unit 206 sends a signal to the servo unit 202 for controlling the optical focusing component 200 to move the focus along the focus-finding direction, wherein the moving path of the focus contains at least three reference focusing positions Xᵢ, Xⱼ, and Xₖ (step S400), and all the distances between the reference focusing positions Xᵢ, Xⱼ, and Xₖ are s (the method of finding the reference points will be further described below).

The control unit 206 drives the optical focusing component 200 for focus adjustment by controlling the servo unit 202, and the control unit 206 controls the image-capturing unit 204 to perform view-finding at the reference focusing positions Xᵢ, Xᵢ, and Xₖ. Thus, the control unit 206 respectively calculates the image contrasts Yᵢ, Yⱼ, and Yₖ (step S402).

In the present embodiment, the coordinates of the vertex can be obtained by randomly choosing three points on the quadratic curve Y=aX²+bX+c in FIG. 3. The quadratic equation Y=aX²+bX+c is solved with (Xᵢ, Yᵢ), (Xᵢ, Yⱼ), and (Xₖ, Yₖ) to give:

Yᵢ=aXᵢ²+bXᵢ+c (1)

Yⱼ=aXⱼ²+bXⱼ+c (2)

Yₖ=aXₖ²+bXₖ+c (3)

### Besides, since the distances between the view-finding points Xᵢ, Xᵢ, and Xₖ are the same,

Xⱼ=Xᵢ+s=Xₖ−s (4)

The following equations can be obtained from foregoing four equations:

bs=(Yₖ−Yᵢ)/2−2asXⱼ (5)

as=(2Yⱼ−Yₖ−Yᵢ)/−2s (6)

The simultaneous equations (1), (2), and (3) are solved to obtain the coefficients a, b, and c (step S404) and which are brought into the quadratic curve Y=aX²+bX+c in FIG. 3. The quadratic curve is then differentiated to obtain Y′=2aX+b. The slope of the optimal image contrast position (Xₘ, Yₘ) is 0, thus,

Y′=2aX+b=0 (7)

### Equation (7) is solved with (Xₘ, Yₘ) to obtain

Y′=2aXₘ+b=0 (8)

The target focusing position Xₘ can be obtained from equation (8) as:

Xₘ=(−b)/(2a)=(−bs)/(2as) (9)

Here a and s are not 0. Equations (5) and (6) are brought into equation (9) to get the target focusing position:

Xₘ=(−bs)/(2as)=Xⱼ+s(Yₖ−Yᵢ)/2(2Yⱼ−Yₖ−Yᵢ) (10)

### In step S406, equation (10) is solved to get the value of the target focusing position Xₘ.

The foregoing reasoning can be skipped in actual implementation, and when the distances between the three reference focusing positions are the same, the control unit 206 can bring the three reference focusing positions directly into equation (10) to calculate the target focusing position Xₘ. In step S408, the control unit 206 drives the optical focusing component 200 for focus adjustment by controlling the servo unit 202, so that the focus of the camera is moved to the target focusing position Xₘ, and the control unit 206 controls the image-capturing unit 204 to capture an image so that instant focusing can be achieved and the exposure time is reduced.

FIG. 5 is a graph of an image contrast with reference points of different distances according to an exemplary embodiment of the present invention. Referring to both FIG. 4 and FIG. 5, in step S400, when taking photo of a subject, the focus of the camera is controlled to move along a focus-finding direction. Wherein the moving path of the focus contains at least three reference focusing positions Xᵢ, Xⱼ, and Xₖ. In step S402, when the reference focusing positions Xᵢ, Xⱼ, and Xₖ are located, the camera is controlled to find views at the reference focusing positions Xᵢ, Xⱼ, and Xₖ so as to obtain image contrasts Yᵢ, Yⱼ, and Yₖ respectively. In the present embodiment, the coordinates of the vertex can be obtained by randomly choosing three points on the quadratic curve Y=aX²+bX+c. (Xᵢ, Yᵢ), (Xⱼ, Yⱼ), and (Xₖ, Yₖ) are brought into the quadratic equation Y=aX²+bX+c, and then the simultaneous equations Yᵢ=aXᵢ²+bXᵢ+c, Yⱼ=aXⱼ²+bXⱼ+c, and Yₖ=aXₖ²+bXₖ+c are solved to obtain the coefficients a, b, and c (step S404), so as to obtain the quadratic curve.

The quadratic curve is differentiated to get Y′=2aX+b. The slope of the maximum image contrast position (Xₘ, Yₘ) is 0, which is the point required, so equation Y′=2aX+b=0 is solved with (Xₘ, Yₘ) and which gives the optimal target focusing position Xₘ=(−b)/(2a) (step S406), wherein a and b have been solved as described above and a is not 0.

After the optimal focusing position Xₘ has been obtained, the focus of the camera is controlled to move to the target focusing position Xₘ (step S408) to complete the entire focusing procedure. If the optimal focusing position Xₘ is a position whereto the stepping motor cannot reach, the focus of the camera is then adjusted to the position (threshold) closest to the optimal focusing position Xₘ.

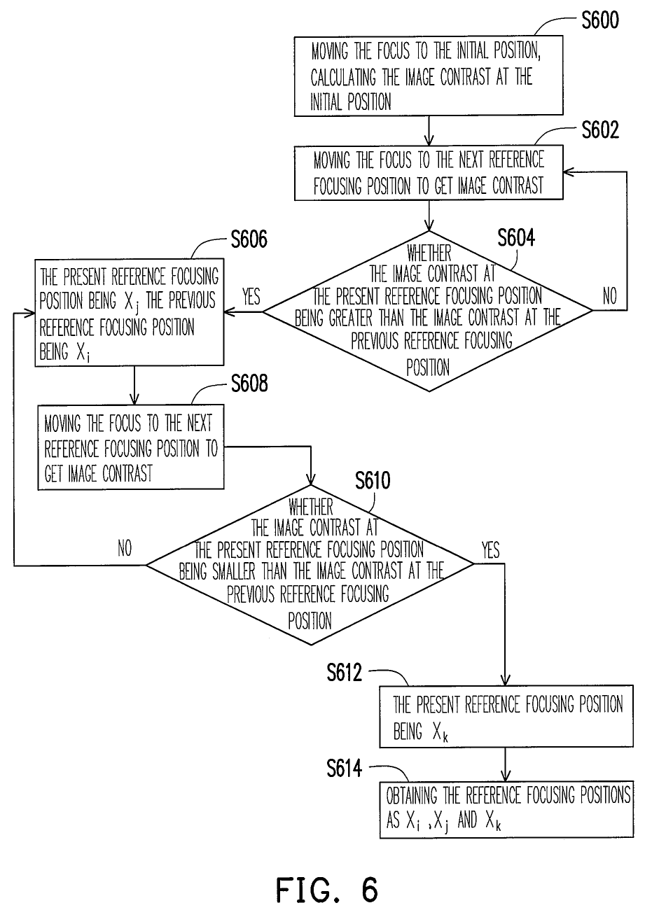

In foregoing embodiment, the reference focusing positions Xᵢ, Xⱼ, and Xₖ are random, and which may also be determined with reference to following embodiments. FIG. 6 is a flowchart illustrating the procedure of finding the reference focusing positions Xᵢ, Xⱼ, and Xₖ according to an exemplary embodiment of the present invention. Referring to FIG. 6, in step S600, the focus of the camera is controlled to move to an initial position. The focus is then moved along a focus-finding direction to the next reference focusing position to obtain another image contrast (step S602). The image contrast at the present reference focusing position is compared with that at the previous reference focusing position (step S604). If the image contrast at the present reference focusing position is smaller than that of the previous reference focusing position, step S602 is returned to, otherwise the present reference focusing position is considered Xⱼ (step S606) and the previous reference focusing position is Xᵢ. The focus is then moved along the focus-finding direction to the next reference focusing position to obtain another image contrast (step S608). The image contrast at the present reference focusing position is compared with that at the previous reference focusing position (step S610). If the image contrast at the present reference focusing position is greater than that at the previous reference focusing position, step S606 is returned to, otherwise the present reference focusing position is considered Xₖ (step S612). Accordingly, the reference focusing positions are Xᵢ, Xⱼ, and Xₖ (step S614).

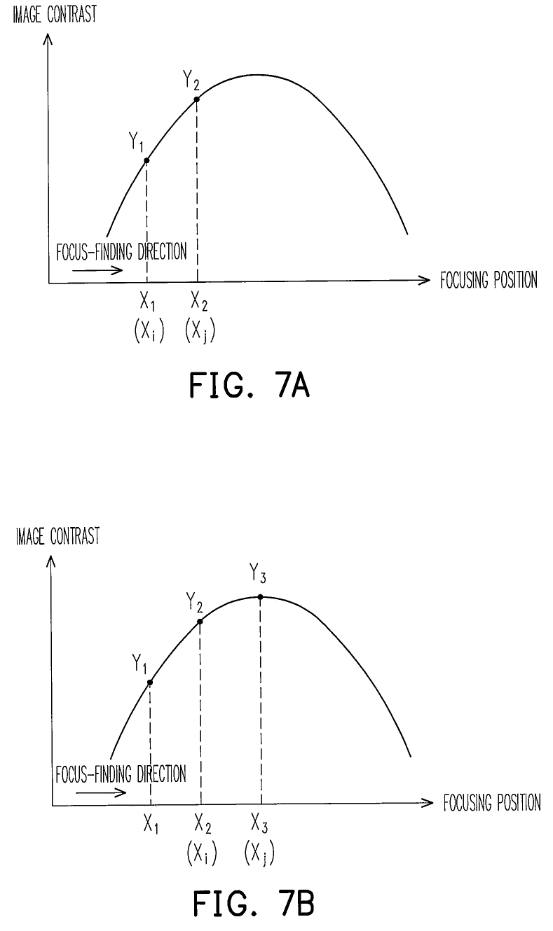

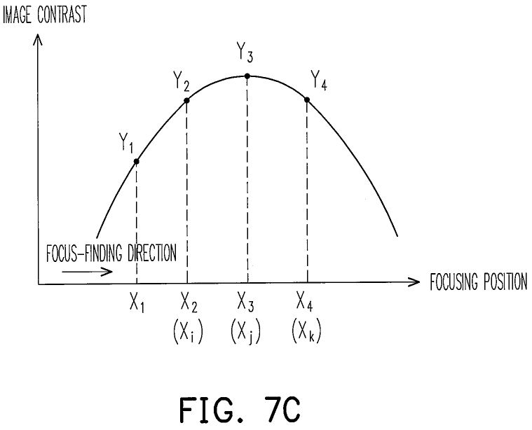

FIGS. 7A˜7C are graphs of an image contrast for finding the reference focusing position according to an exemplary embodiment of the present invention. Referring to FIGS. 6, 7A, 7B, and 7C, for example, the focus of the camera is controlled to move to an initial position (reference focusing position X₁) and an image contrast Y₁ is obtained (step S600). Since the reference focusing position X₁ is the first focusing position, the focus is controlled to move along a focus-finding direction to the next reference focusing position X₂ to obtain another image contrast Y₂ (step S602). In step S604, the image contrast Y₂ at the present reference focusing position is compared with the image contrast Y₁ of the previous reference focusing position. In the present embodiment, the image contrast Y₂ at the present reference focusing position is greater than the image contrast Y₁ of the previous reference focusing position so that previous reference focusing position X₁ is considered as Xᵢ and the present reference focusing position X₂ as Xⱼ (step S606) as shown in FIG. 7A. The focus is then controlled to move along the focus-finding direction to the next reference focusing position X₃ to obtain another image contrast Y₃ (step S608), and Y₃ is compared with Y₂ (step S610). As shown in FIG. 7B, in the present embodiment, Y₃ is greater than Y₂, then X₂ is set as Xᵢ and X₃ as Xⱼ (return to step S606), and the focus is controlled to move along the focus-finding direction to the next reference focusing position X₄ to obtain another image contrast Y₄ (step S608). As shown in FIG. 7C, Y₄ is compared with Y₃ (step S610), in the present embodiment, Y₄ is smaller than Y₃, then Y₄ is considered as Xₖ (step S612), so that the reference focusing positions Xᵢ, Xⱼ, and Xₖ are obtained as X₂, X₃, and X₄ respectively (step S614).

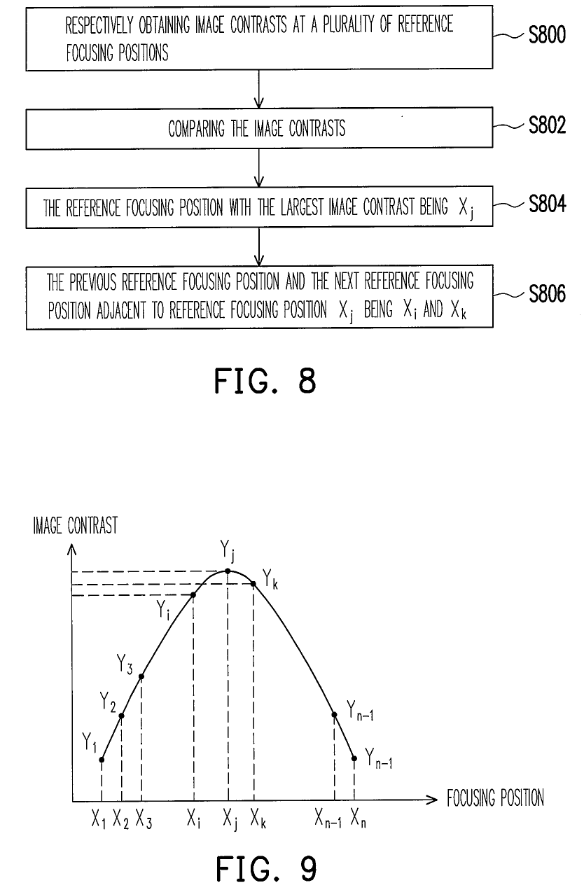

FIG. 8 is a flowchart illustrating the procedure of finding the reference focusing positions Xᵢ, Xⱼ, and Xₖ according to another exemplary embodiment of the present invention. FIG. 9 is another graph of an image contrast for finding the reference focusing position according to an exemplary embodiment of the present invention. Referring to both FIG. 8 and FIG. 9, in step S800, a plurality of image contrasts are respectively obtained at a plurality of corresponding reference focusing positions in the moving path of the focus. In step S802, the image contrasts of various reference focusing positions are compared with each other. The reference focusing position with the largest image contrast is considered as Xⱼ (step S804), and the previous reference focusing position and the next reference focusing position adjacent to the reference focusing position Xⱼ are respectively considered as Xᵢ, and Xₖ (step S806).

Referring to FIG. 9, n reference points X₁˜X_{N} are located first, and then the image contrasts Y₁˜Yₙ corresponding to various reference points are calculated. The maximum image contrast among Y₁˜Yₙ is considered as Yⱼ, and the focusing position thereof is Xⱼ. Next, the previous reference point of Xⱼ is considered as Xᵢ and the corresponding image contrast as Yᵢ. After that, the next reference point of Xⱼ is considered as Xₖ and the corresponding image contrast as Yₖ. Accordingly the reference focusing positions Xᵢ, Xⱼ, and Xₖ are obtained. The value of n (the number of reference points X₁˜Xₙ) may be determined according to user's requirement, wherein n≧3. The lower the value of n is, the less the time consumed for finding reference points is. For example, if 5 points are located randomly, only 5 image contrasts are to be calculated to find the reference focusing positions Xᵢ, Xⱼ, and Xₖ. Then a corresponding method described above is used based on whether the distances between the reference view-finding points are the same or not, so as to obtain the target focusing position Xₘ instantly.

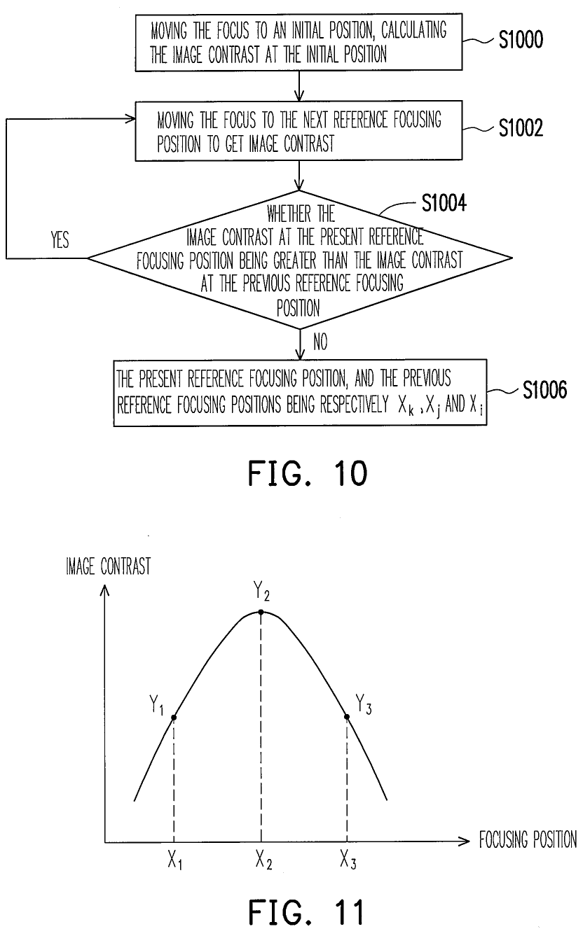

FIG. 10 is a flowchart illustrating the procedure of finding the reference focusing positions Xᵢ, Xⱼ, and Xₖ according to yet another exemplary embodiment of the present invention. FIG. 11 is yet another graph according to an exemplary embodiment of the present invention. Referring to both FIG. 10 and FIG. 11, for example, in step S1000, the focus is moved to the initial position X₁ by the stepping motor of the servo unit 202, and the image contrast Y₁ is calculated. In step S1002, the focus is further moved to the next reference focusing position X₂ and the image contrast Y₂ is calculated. The image contrast Y₂ at the present reference focusing position is compared with the image contrast Y₁ at the previous reference focusing position (step S1004). In the present embodiment, Y₂ is greater than Y₁, so step S1002 is returned to and the focus is moved to the next reference focusing position X₃, and image contrast Y₃ is calculated. The image contrast Y₃ at the present reference focusing position is compared with the image contrast Y₂ at the previous reference focusing position (step S1004). In the present embodiment, Y₃ is smaller than Y₂, so that the present reference focusing position X₃, the previous reference focusing position X₂, and the even previous reference focusing position X₁ are respectively Xₖ, Xⱼ, and Xᵢ (step S1006). Next, the corresponding methods described above are used based on whether the distances between the reference view-finding points are the same or not, so as to get the target focusing position Xₘ instantly.

In overview, according to the camera focusing method in the present invention, views are found at the reference positions Xᵢ, Xⱼ, and Xₖ of three random points to respectively obtain image contrasts Yᵢ, Yⱼ, and Yₖ, and which are brought into the quadratic equation Y=aX²+bX+c to solve coefficients a, b, and c, so that the optimal target focusing position Xₘ=(−b)/(2a)=Xⱼ+s(Yₖ−Yᵢ)/2(2Yⱼ−Yₖ−Yᵢ). Accordingly, the optimal focusing position can be obtained with fewer reference points, simpler procedure and calculation, and reduced exposure time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A camera focusing method for controlling a focus of the camera to move to a target focusing position to capture an image, the focusing method comprising:
moving the focus along a focus-finding direction, wherein the moving path of the focus comprises at least three reference focusing positions Xᵢ, Xⱼ, and Xₖ, and all of the distances between the reference focusing positions Xᵢ, Xⱼ, and Xₖ are s;
controlling the camera to focus at the reference focusing positions Xᵢ, Xⱼ, and Xₖ and obtain image contrasts Yᵢ, Yⱼ, and Yₖ respectively;
calculating the target focusing position Xₘ=Xⱼ+[s(Yₖ−Yᵢ)/2(2Yⱼ−Yₖ−Yᵢ)]; and
controlling the focus of the camera to move to the target focusing position Xₘ.

2. The focusing method as claimed in claim 1 further comprising controlling the focus of the camera to move to an initial position.

3. The focusing method as claimed in claim 1 further comprising:
moving the focus of the camera along the focus-finding direction to the next reference focusing position and obtaining another image contrast if the image contrast at the present reference focusing position being greater than the image contrast at the previous reference focusing position; and
the present reference focusing position, the previous reference focusing position, and the even previous reference focusing position being respectively Xₖ, Xⱼ, and Xᵢ if the image contrast at the present reference focusing position is smaller than the image contrast at the previous reference focusing position.

4. The focusing method as claimed in claim 1 further comprising:
respectively obtaining a plurality of image contrasts at a plurality of reference focusing positions in the moving path of the focus;
comparing the image contrasts;
the reference focusing position with the largest image contrast being Xⱼ; and
the previous reference focusing position and the next reference focusing position adjacent to the reference focusing position Xⱼ being respectively Xᵢ and Xₖ.

5. A camera focusing method for controlling a focus of the camera to move to a target focusing position to capture an image, the focusing method comprising:
moving the focus along a focus-finding direction, wherein the moving path of the focus comprises at least three reference focusing positions and the reference focusing positions are respectively Xᵢ, Xⱼ, and Xₖ;
controlling the camera to focus at the reference focusing positions Xᵢ, Xⱼ, and Xₖ and obtain image contrasts Yᵢ, Yⱼ, and Yₖ respectively;
solving the simultaneous equations: Yᵢ=aXᵢ²+bXᵢ+c, Yⱼ=aXⱼ²+bXⱼ+c, and Yₖ=aXₖ²+bXₖ+c to obtain the coefficients a, b, and c;
calculating the target focusing position Xₘ=(−b)/(2a); and
controlling the focus of the camera to move to the target focusing position Xₘ.

6. The focusing method as claimed in claim 5 further comprising controlling the focus of the camera to move to an initial position.

7. The focusing method as claimed in claim 5 further comprising:
moving the focus along a focus-finding direction to the next reference focusing position and obtaining another image contrast if the image contrast at the present reference focusing position being greater than the image contrast at the previous reference focusing position; and
the present reference focusing position, the previous reference focusing position, and the even previous reference focusing position being respectively Xₖ, Xⱼ, and Xᵢ if the image contrast at the present reference focusing position being smaller than the image contrast at the previous reference focusing position.

8. The focusing method as claimed in claim 5 further comprising:
obtaining a plurality of image contrasts at a plurality of reference focusing positions in the moving path of the focus;
comparing the image contrasts;
the reference focusing position with the largest image contrast being Xⱼ; and
the previous reference focusing position and the next reference focusing position adjacent to the reference focusing position Xⱼ being respectively Xᵢ and Xₖ.

9. The focusing method as claimed in claim 5, wherein the reference focusing positions Xᵢ, Xⱼ, and Xₖ are equidistant.

10. A camera focusing system, comprising:
an optical focusing component;
a servo unit, coupled to the optical focusing component for driving the optical focusing component to move a focus of the camera along a focus-finding direction, wherein the moving path of the focus comprises at least three reference focusing positions Xᵢ, Xⱼ, and Xₖ, and all the distances between the reference focusing positions Xᵢ, Xⱼ, and Xₖ are s;
a image-capturing unit, disposed on the optical path of the optical focusing component for capturing an image; and
a control unit, electrically connected to the servo unit and the image-capturing unit, controlling the servo unit to move the focus to a target focusing position, controlling the image-capturing unit to capture an image; wherein the control unit controls the image-capturing unit and the servo unit to find views at the reference focusing positions Xᵢ, Xⱼ, and Xₖ and obtain image contrasts Yᵢ, Yⱼ, and Yₖ respectively; the control unit calculates the target focusing position Xₘ=Xⱼ+[s(Yₖ−Yᵢ)/2(2Yⱼ−Yₖ−Yᵢ)]; and the control unit controls the focus of the camera to move to the target focusing position Xₘ.

11. The focusing system as claimed in claim 10, wherein the control unit further controls the servo unit to move the focus to an initial position.

12. The focusing system as claimed in claim 10, wherein the control unit further moves the focus along a focus-finding direction to the next reference focusing position and obtains another image contrast if the image contrast at the present reference focusing position is greater than the image contrast at the previous reference focusing position; and the present reference focusing position, the previous reference focusing position, and the even previous reference focusing position are respectively Xₖ, Xⱼ, and Xᵢ if the image contrast at the present reference focusing position is smaller than the image contrast at the previous reference focusing position.

13. The focusing system as claimed in claim 10, wherein the control unit further obtains a plurality of image contrasts at a plurality of reference focusing positions in the moving path of the focus; the control unit compares the image contrasts to select the reference focusing position with the largest image contrast as Xⱼ; and the previous reference focusing position and the next reference focusing position adjacent to the reference focusing position Xⱼ are respectively Xᵢ and Xₖ.
